(19) United States
(12) Patent Application Publication
(10) Pub. No.: US 2025/0045546 A1
(43) Pub. Date: Feb. 6, 2025

(54) Parallax-Based 3D Measurement System Using Overlapping FsOV

(71) Applicant: ZEBRA TECHNOLOGIES CORPORATION, Lincolnshire, IL (US)

(72) Inventors: Darran Michael Handshaw, Sound Beach, NY (US); Edward Barkan, Miller Place, NY (US); Andrea Mirabile, London (GB); Mark Drzymala, Saint James, NY (US)

(21) Appl. No.: 18/228,110

(22) Filed: Jul. 31, 2023

(51) Int. Cl. G06K 7/10; G06T 7/60

(52) U.S. Cl. CPC G06K 7/1096; G06K 7/10861; G06T 7/60

(57) ABSTRACT

Systems and methods for performing three-dimensional measurements are disclosed herein. An example system includes an imaging system with a scan platter defining a spatial region within which an object may be imaged. The imaging system has first optics configured to image a first field of view of the imaging system, and second optics configured to image a second field of view of the imaging system. The second field of view spatially overlaps at least partially with the first field of view to form an overlap region, with the overlap region being a three-dimensional volume extending along a length of the scan platter. The system may further include a processor configured to analyze images of the first and second fields of view and determine at least one common point between the first and second images. The processor then further determines three-dimensional information of an object from the determined common point.

### BACKGROUND

Conventional barcode scanning system workflows limit the scanning to one item. Typically, the items are scanned in succession one after another in one or more trigger sessions. Items enter one or more fields of view (FsOV) of a scanner and the scanner images the item or target and decodes a barcode in the region. Often a single item may erroneously be placed in a field of view (FOV) of the scanner, and the item may be scanned multiple times as it rests within the FOV. An object may be scanned in one FOV of a scanner, and the object may then be moved across into another FOV of the scanner where the scanner then erroneously rescans the object which causes disruptions in scanning of objects resulting in longer overall scan times.

Modern imaging systems are also being used for product recognition, shape recognition, object recognition, for detecting ticket switching, and scan avoidance. As such, the imaging systems often require depth information of an object in addition to the planar image of the object. Adding depth imaging and detection capabilities can require additional components such as additional cameras at various relative positions (above a target etc.) which are bulky and require more real estate at specific mounting positions which may not be feasible for some implementations. Further, the additional hardware required to obtain the depth information comes with additional financial cost and requires additional setup time and tuning.

Accordingly, there remains a demand for improvements to barcode scanning systems and imaging systems for increased scanning accuracy and efficiency in multi-FOV systems.

### SUMMARY

In an embodiment, the present invention is a bioptic indicia including a housing having a lower portion with a platter extending along a horizontal plane, and a tower region extending above the platter away from the platter. The tower region has a second window, and the first and second windows each have at least one field of view (FOV) passing therethrough. The platter includes: a first window, a proximal edge toward the tower region, a distal edge away from the tower region, and two lateral sides opposite each other between the proximal edge and the distal edge. The platter further has a length extending between the proximal edge and the distal edge with the length being generally parallel to the lateral sides and midway between the lateral sides defining a centerline of the platter, and a width extending between the two lateral sides of the platter. First optics are positioned in the housing to image a first FOV of the imaging system, the first FOV extending along a first optical axis through the second window. Second optics are positioned in the housing to image a second FOV of the imaging system, the second FOV extending along a second optical axis through the second window. The second FOV spatially overlaps with the first FOV to form an overlap region. The overlap region is a three-dimensional volumetric region that extends along at least 80% of the centerline of the scan platter, and the overlap region is a volumetric region in which an object maybe me imaged.

In a variation of the current embodiment, the system further includes at least one imaging sensor configured to receive images of the first field of view and the second field of view. In the current variation, the imaging sensor may be disposed perpendicularly to the top surface of the scan platter. In another variation of the current embodiment, the first optics further rotate the first field of view around the first optical axis, and the second optics rotate the second field of view around the second optical axis.

In variations of the current embodiment, the bioptic indicia reader further includes a processor and computer-readable media storage having machine-readable instructions stored thereon that, when the machine-readable instructions are executed, cause the system to: capture, by the first region of the imaging sensor, first image data of an object in the first FOV; capture, by the second region of the imaging sensor, a second image data of the object in the second FOV; evaluate, by the processor, the first image data to identify the object in the first FOV; evaluate, by the processor, the second image data to identify the object in the second FOV; determine, by the processor, three-dimensional information pertaining to the object from the first image data and second image data. In embodiments, the three-dimensional information may include one or more of a distance of the object, a shape of the object, a size of one or more dimensions of the object, an orientation of the object, one or more curvatures of a surface of an object, a number of distinct objects, and one or more dimensions or distances between elements or features of an object. In embodiments, to determine the three-dimensional information, the machine-readable instructions further cause the system to: identify, by the processor, at least one common point between the first image and the second image; and determine, by the processor, the three-dimensional information of the object from the determined at least one common point.

In another embodiment, the present invention is a method of performing a three-dimensional measurement, the method including: capturing, on a first region of an imaging sensor, a first image of an object in a first FOV, the first field of view being along a first optical axis through a vertical window; capturing, on a second region of the imaging sensor with the second region being laterally adjacent to the first region, a second image of the object in a second FOV, the second FOV being along a second optical axis through the vertical window, wherein at least at portion of the object is disposed in an overlap region of the first FOV and the second FOV; and determining, by the processor, three-dimensional information pertaining to the object from the first image and second image.

In a variation of the current embodiment, the three-dimensional information includes at least one of a distance of the object, a shape of the object, a size of one or more dimensions of the object, an orientation of the object, one or more curvatures of a surface of an object, a number of distinct objects, and one or more dimensions or distances between elements or features of an object. In variations of the current embodiment, the first field of view is rotated about a first optical axis and the second field of view is rotated about a second optical axis. In variations of the current embodiment, the overlap region spans at least 80% of a length of a surface of a scan platter. In yet more variations of the current embodiment, the overlap region has a volume of 80 cubic inches or greater. In further variations of the current embodiment, the imaging sensor captures the first image on a first region of the imaging sensor, and the second image on a second region of the imaging sensor, the second set of pixels being a different set of pixels than the first set of pixels and the second region being disposed laterally to the first region.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a perspective view of an example checkout workstation in accordance with the teachings of this disclosure.

FIG. 2 illustrates a top-down view of an example imaging system of FIG. 1, showing a first sub-field of view (FOV), a second sub-FOV, and a third sub-FOV.

FIG. 3 illustrates a side view of the example imaging system of FIG. 2.

FIG. 4 illustrates a perspective view of the example imaging system of FIGS. 2 and 3.

FIG. 5 illustrates a front view of a raised housing and showing a first sub-FOV and second sub-FOV overlapping to form an overlap region.

FIG. 6 illustrates an example imaging sensor for capturing images of one or more fields of view (FsOV).

FIG. 7 illustrates a flowchart for a method for performing a three-dimensional measurement using an imaging system.

FIG. 8 illustrates a top view of a target object being partially disposed in an overlap region of the imaging system of FIGS. 2-5.

FIG. 9 illustrates an example processor platform coupled to a first image sensor and a second image sensor that can be used to implement the teachings of this disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The disclosed systems and methods enable the ability to determine three-dimensional information of objects in an overlap region of fields of view (FsOV) of an imaging system. As described herein, when an object is presented in an overlap region of multiple (two or more) FsOV, one or more imaging sensors captures a plurality (two or more) images of the object. A processor may analyze the plurality of images and determine a common point or feature in each of the images to determine the three-dimensional information from. In examples, the system includes a scan platter with a top surface having a length and width. The length and width together define a spatial region within which an object may be imaged. First optics are configured to image a first field of view of the imaging system with the first field of view extending along a first optical axis through the spatial region defined by the length and width of the scan platter. Second optics are configured to image a second field of view of the imaging system, the second field of view extending along a second optical axis through the spatial region defined by the length and width of the scan platter. The second field of view spatially overlaps at least partially with the first field of view to form the overlap region. In examples, the overlap region is a three-dimensional volumetric region that extends along at least 80% of the length of the scan platter.

The described system may capture, by one or more imaging sensors of, a first image of an object in the first field of view, and capture, by the one or more imaging sensors, a second image of the object in the second field of view. The processor then identifies if the object is at least partially disposed in the overlap region and (i) determines, if the object is identified as being at least partially disposed in the overlap region, three-dimensional information pertaining to the object from the first image and second image, or (ii) not determine, if the object is identified as not being at least partially disposed in the overlap region, three-dimensional information pertaining to the object. The disclosed systems and methods may be used to provide three-dimensional information including one or more of identification information associated with an object, a distance of the object, a shape of the object, a size of one or more dimensions of the object, an orientation of the object, one or more curvatures of a surface of an object, a number of distinct objects, identification of features of an object, and one or more dimensions or distances between elements or features of an object.

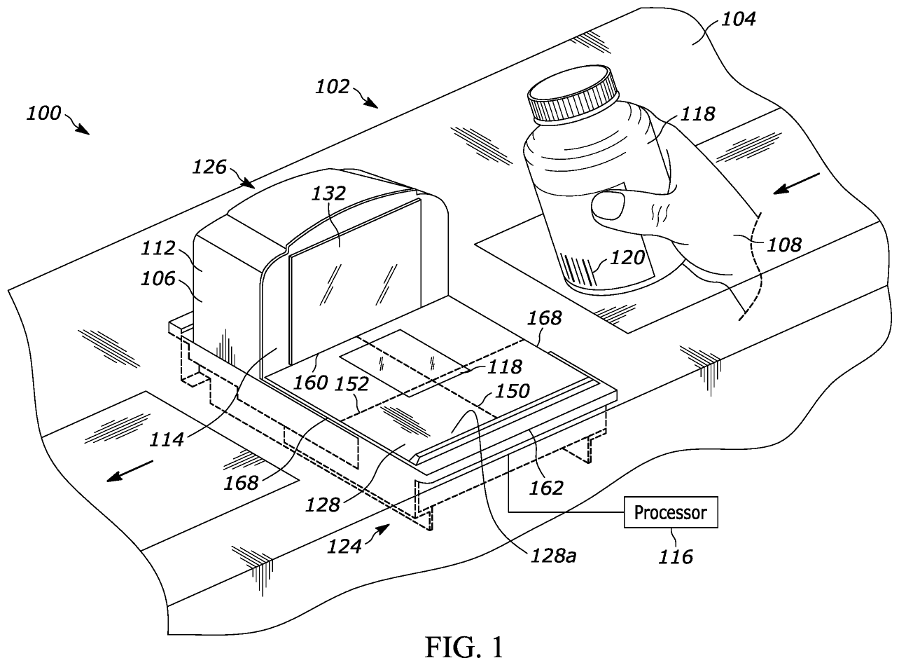

FIG. 1 illustrates a perspective view of an example point-of-sale (POS) system 100 in accordance with the teachings of this disclosure. In the example shown, the system 100 includes a workstation 102 with a counter 104 and a bi-optical (also referred to as “bi-optic”) imaging system 106. The POS system 100 is often managed by a store employee such as a clerk 108. However, in other cases, the POS system 100 may be part of a so-called self-checkout lane where instead of a clerk, a customer is responsible for checking out his or her own products. The imaging system 106 may also be referred to as a bi-optic scanner, barcode reader, or an indicia reader. As used herein, “indicia” refers to a visual feature that encodes a payload and where the payload can be extracted by a decode module that processes image data associated with the indicia. In various examples, indicia can include a 1D barcode, 2D barcode, DPM code, dot matrix code, QR code, etc.

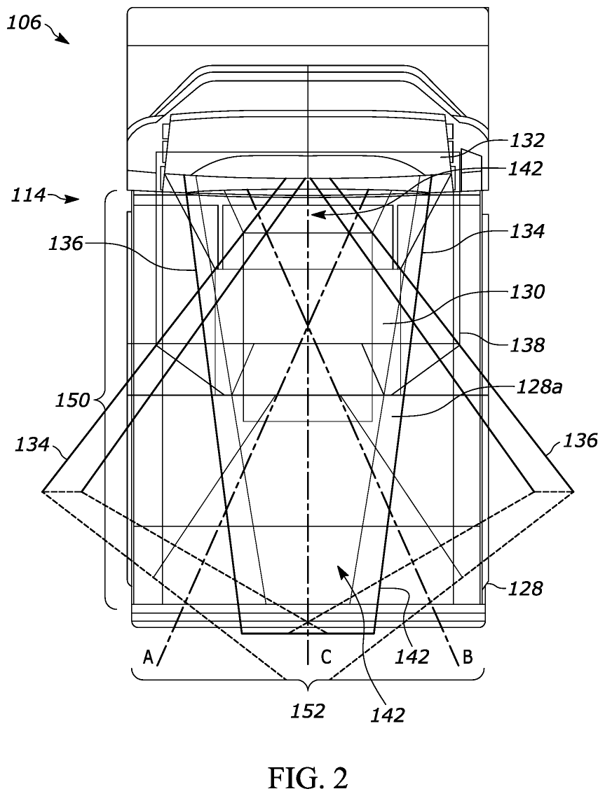

The imaging system 106 includes a housing 112 that houses an optical imaging assembly 114. The optical imaging assembly 114 includes one or more image sensors and is communicatively coupled to a processor 116. The image sensors may include one or more color cameras, one or more monochrome imagers, one or more optical character readers, etc. The processor 116 may be disposed within the imaging system 106 or may be in another location. The optical imaging assembly 114 includes one or more fields of view (FsOV) as described in further detail below and in connection with FIGS. 2, 3 and 4. Further, the optical imaging assembly 114 is operable to capture one or more images of one or more targets 118 entering and/or being within the one or more FsOV. While referenced herein as one or more targets 118, a target 118 may also be referred to herein as an object of interest, or in short, an object. In any embodiment or description, the target 118, or object of interest, includes one or more product codes 120 or indicia indicative of information associated with the target 118.

In practice, the targets 118, depicted as a bottle in the example shown, is swiped past the imaging system 106. While illustrated as a single target in FIG. 1 for simplicity and clarity, the bottle may be interpreted to represent multiple targets 118 to be imaged by the optical imaging assembly 114, and that the multiple targets 118 may be within one or more of the FsOV of the optical imaging system 114 simultaneously or nearly simultaneously. In doing so, one or more product codes 120 associated with the targets 118 are positioned within the FOV of the optical imaging assembly 114. In the example shown, the product code 120 is a bar code. However, the product code 120 may alternatively be a radio-frequency identification (RFID) tag and/or any other product identifying code. Additionally, the current systems and methods may determine three-dimensional information of a single target or the multiple targets in the FsOV of the imaging system 106.

In response to capturing the one or more images (e.g., image data), in an example, the processor 116 processes the image data to determine an absence, a presence, movement, etc. of the targets 118 within and/or relative to the FOV. Specifically, the processor 116 processes the image data in real time to determine when one or more of the targets 118 enters the FsOV of the optical imaging assembly 114, when one or more targets 118 are within the FsOV of the optical imaging assembly 114, and/or when one or more of the targets 118 exits the FOV of the optical imaging assembly 114.

In some examples, the optical imaging assembly 114 has a relatively short focal length that allows the foreground in which the one or more targets 118 may be present to be better isolated from the background, thereby allowing for the targets 118 to be more easily identified and/or tracked within the FsOV. In some examples, processing the one or more images allows the processor 116 to identify an object that is moving in the FOV and to identify an object that is not moving in the FOV. The processing may also allow the processor 116 to differentiate between a larger item(s) within the FsOV and a smaller item(s) within the FsOV, a direction that the targets 118 are moving within the FOV, etc. The system and methods may determine three-dimensional information allowing for the processor to identify a distance and location of the target(s) 118 within the FsOV, a size of the target(s) 118, various features of the targets (e.g., identify the top of the bottle in FIG. 1, identify a curvature of the bottle, height of the bottle, etc.).

The housing 112 includes a lower housing 124 and a raised housing 126. The lower housing 124 may be referred to as a first housing portion and the raised housing 126 may be referred to as a tower region or a second housing portion. The lower housing 124 includes a top portion 128 with a first optically transmissive window 130. The first window 130 is positioned within the top portion 128 along a generally horizontal plane relative to the overall configuration and placement of the imaging system 106. In some embodiments, the top portion 128 may include a removable or a non-removable platter (e.g., a weighing platter). The top portion 128 may also be referred to herein as a “scan platter” or simply as a “platter” with a top surface 128a over which an object may be scanned or imaged. The top surface 128a has a length 150 that extends away from the raised housing 126, and a width 152 that is perpendicular to the length 150 of the top surface 128a (the length 150 and width 152 more clearly shown in FIG. 2). The top portion 128 has a proximal edge 160 toward the raised housing 126, and a distal edge 162 away from the raised housing 126. The top portion 128 additionally has two lateral edges 168 that extend between the proximal edge 160 and the distal edge 162 with the lateral sides 168 disposed opposite each other. The length 150 of the top surface 128a extends from the proximal edge 160 to the distal edge 162 with the length being generally parallel to the lateral sides 168. The length may also be taken at a midpoint between the lateral sides defining a centerline of the platter as illustrated in FIG. 1. The width 152 of the top surface 128a is taken as the width between the two lateral sides 168. In examples, the top surface 128a has a same length 150 and width 152 of the top portion 128. In some examples, the top surface 128a may be inset into the top portion 128 which may reduce the length and width of the top surface 128a to be smaller than that of the top portion 128.

The top portion 128 can also be viewed as being positioned substantially parallel with the counter 104 surface. As set forth herein, the phrase “substantially parallel” means +/−10° of parallel and/or accounts for manufacturing tolerances. It's worth noting that while, in FIG. 1, the counter 104 and the top portion 128 are illustrated as being about co-planar, that does not have to be the case for the scan platter and the counter 104 to be considered substantially parallel. In some instances, the counter 104 may be raised or lowered relative to the top surface 128a of the top portion 128, where the top portion 128 is still viewed as being positioned substantially parallel with the counter 104 surface. The raised housing 126 is configured to extend above the top portion 128 and includes a second optically transmissive window 132 positioned in a generally upright plane relative to the top portion 128 and/or the first window 130, and therefor ethe second window may be referred as the upright or vertical window. Note that references to “upright” include, but are not limited to, vertical. Thus, as an example, something that is upright may deviate from a vertical axis/plane by as much as 45 degrees.

The optical imaging assembly 114 includes the one or more image sensor(s) configured to image targets in the one or more FsOV, and further, in examples, to read the product code 120 through at least one of the first and second windows 130, 132. In the example shown, the FsOV include a first sub-field of view (FOV) 134 (the first sub-FOV 134 is more clearly shown in FIG. 2), a second sub-FOV 136 (the second sub-FOV 136 is more clearly shown in FIG. 2), a third sub field of view 138 (the third sub-FOV 138 is more clearly shown in FIG. 2). In the illustrated example, the first and second sub-FsOV 134 and 136 are FsOV through the second window 132, while the third sub-FOV 138 is through the first window 130. Determining three-dimensional information of the target 118 through the first and second windows 130, 132 using the optical imaging assembly 114 allows for determining a position of the target and image of the swipe path of the target 118 through the FsOV.

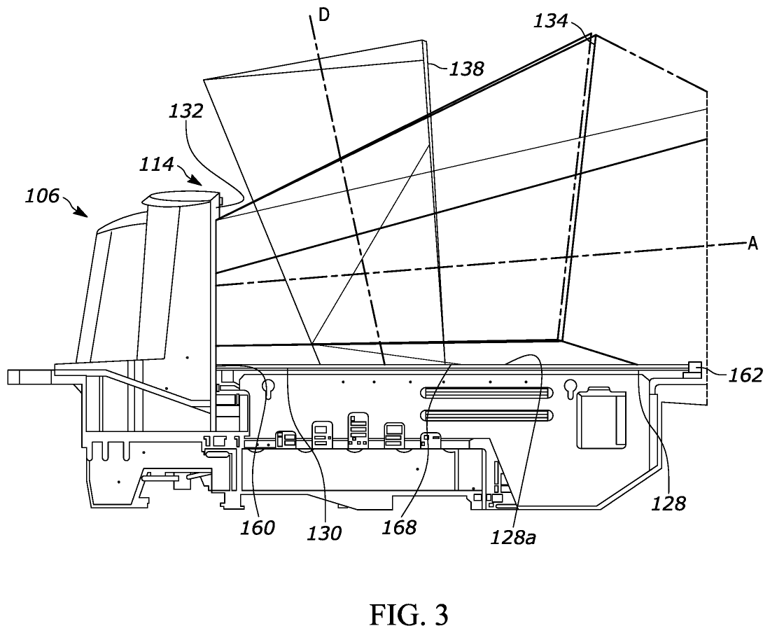

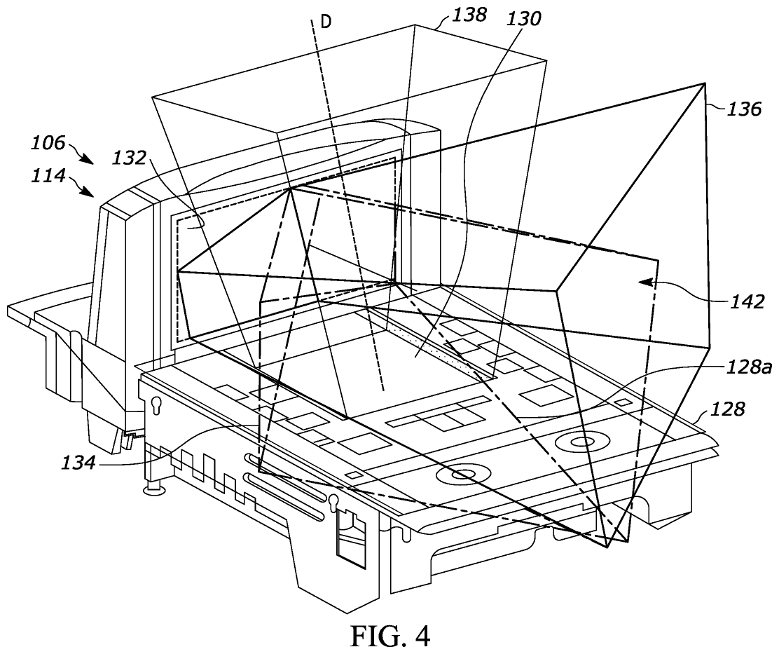

FIG. 2 illustrates a top-down view of an example imaging system 106 of FIG. 1, showing the top surface 128a of the top portion 128 with the first and second sub-FsOV 134, and 136 projecting from the second window 132, and the third sub-FOV 138 projecting from the first window 130. FIG. 3 illustrates a side view of the same example imaging system 106 of FIG. 2, and FIG. 4 illustrates a perspective view of the imaging system 106 of FIGS. 2 and 3. As illustrated in FIG. 2, the first sub-FOV 134 extends along a first axis A, and the second sub-FOV 136 extends along a second axis B with the first and second axis's intersection above the surface 128a of the scan platter. The first and second axes, and corresponding first and second sub-FsOV 134 and 136 extend through a spatial region above the platter. In implementations, optics are disposed in the housing 112 and are positioned to guide the first and second sub-FsOV 136 and 136 such that the first sub-FOV 134 and the second sub-FOV 136 intersect above the first window 130 in an overlap region 142 of the imaging system 106.

The overlap region 142 extends along an axis D, and the overlap region 142 is the general area where the target 118 is expected to be presented for image capture by the imaging system 106. In some cases, the optics can be arranged to cause the first sub-FOV 134 and the second sub-FOV 136 to intersect partially. In other instances, the optics can be arranged to cause the first sub-FOV 134 and the second sub-FOV 136 to intersect fully. In still other instances, the optics can be arranged to cause a centroidal axis of each of the first sub-FOV 134 and the second sub-FOV 136 to intersect with or without regard for the cross-sectional dimensions of the FsOV. In any embodiments, the overlap region 142 includes any spatial overlap of the first and second sub-FsOV 134 and 136 which may be partial overlaps of the first and second sub-FsOV 134 and 136.

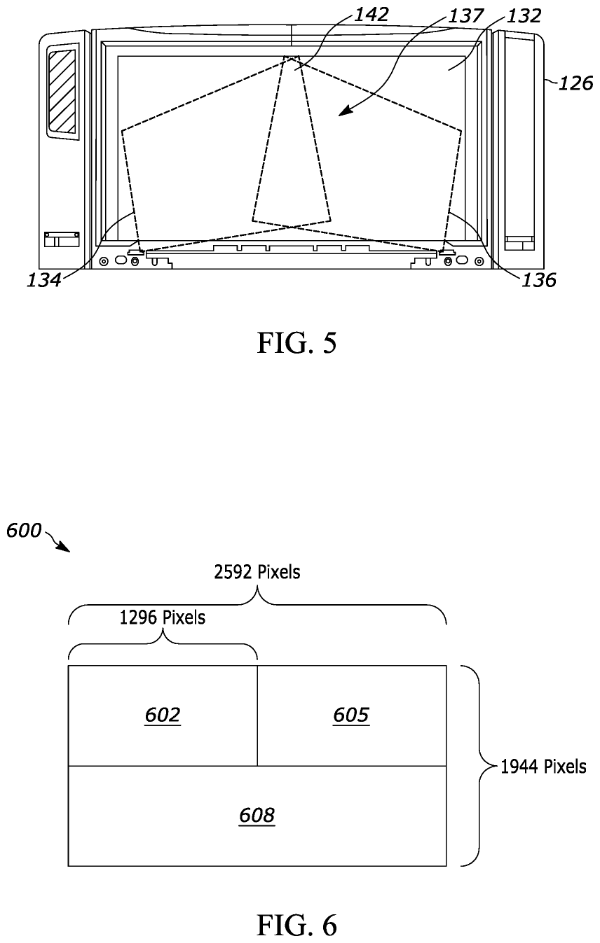

The overlap region 142 is a three-dimensional volumetric region that extends above the top surface 128a across at least a portion of the width 152 of the top surface 128a, and along at least a portion of the length 150 of the top surface 128a. The first and second sub-FsOV 134 and 136 may overlap at the second window 132 with the second window 132 being a transmissive window to image the first and second sub-FsOV 134 and 136 through. At the plane of the second window 132, the overlap region 142 may cover less than 5% of the area of the second window 132, less than 10% of the area of the second window 132, less than 15% of the area of the second window 132, or less than less than 25% of the area of the second window 132. The overlap region 142 at the second window 132 may have different widths along a height of the second window 132. For example, as illustrated in FIG. 5, the overlap region 142 may substantially reach a point toward the top of the second window 132, widen to a maximum width as further down the second window 132, and end at another point toward the bottom of the second window 132. In examples, the maximum width of the overlap region 142 may be about 1 inch, about 1.5 inches, about 2 inches, about 5 inches, less than 1 inch, less than 2 inches, less than five inches, or less than 10 inches. In examples, the overlap region covers at least 60%, at least 70%, at least 75%, or at least 80% of the height of the second window 132. In a specific example, the overlap region 142 spans at about 80% of the second window 132.

The overlap region 142 may extend across the width 152 of the top surface 128a at greater than 20%, greater than 40%, greater than 50%, greater than 75%, or greater than 80% of the width 152. In examples, the overlap region 142 may have varying widths as the overlap region 142 extends along the length of the top surface 128a. In an example, the overlap region may extend along at least 20%, 40%, 50%, 75%, 80%, or at least 90% of the length 150 of the top surface 128a of the scan platter. The overlap region 142 may have a volume of greater than 40 cubic inches, greater than 50 cubic inches, greater than 60 cubic inches, greater than 70 cubic inches, greater than 80 cubic inches, greater than 100 cubic inches, less than 200 cubic inches, less than 150 cubic inches, or less than 100 cubic inches. In a specific example, the overlap region has a volume of about 96 cubic inches. In embodiments, the overlap region 142 may have a volume as required to image an object, or portion of an object, to determine three-dimensional information associated with the object or a feature or element of the object.

The overlap region 142 is a region in which a target may be imaged in both the first sub-FOV 134 and the second sub-FOV either simultaneously or sequentially, to determine three-dimensional information of an object in the overlap region 142. An object may be partially or entirely disposed in the overlap region 142 and three-dimensional information may be determined for portions of, or for an entire object, either partially or entirely disposed in the overlap region 142. In examples, the object may be first detected in one of the first or second sub-FOV 134 or 136, and the system 106 may determine that the object has moved into the overlap region 142. The imaging system 106 may then capture a plurality of images of the object to determine three-dimensional information associated with the object.

In some implementations, the imaging system 106 may include the third sub-FOV 138 that projects from the first window 130. The third sub-FOV 138 extends along a third axis D. A third set of optics may manipulate the third sub-FOV 138 to extend above the top surface 128a of the top portion 128, with the third sub-FOV 138 extending substantially perpendicular to the first and second sub-FsOV 134 and 136. Accordingly, the third axis C is orthogonal to, or substantially orthogonal to both the first axis A and second axis B. While described herein as first, second, and third axes, the first axis A, second axis B, and third axis C may also be referred to herein as first, second, and third optical axes. In examples, the overlap region 142 may further be defined by the region of intersection of the first, second, and third sub-FOVs 134, 136, and 138. In such examples, the overlap region 142 is further defined by the additional third sub-FOV 138 of the imaging system 106, and more specifically, may be defined as the intersection of all three of the first, second, and third sub-FsOV 134, 136, and 138. The overlap region 142 may be further defined as the overlap of the first, second, and third sub-FsOV 134, 136, and 138. In examples, the third sub-FOV 138 may extend upward and overlap with the first and second sub-FsOV 134 and 136 by about 4 inches. The overlap region 142 may be a volumetric region with a volume between 80 to 90 cubic inches. The third sub-FOV 138 may extend further and the overlap region 142 may have volumes greater than 90 cubic inches.

The imaging system 106 includes one or more imaging sensors configured to image the first FOV 134, second FOV 136, and, in implementations that include a third sub-FOV 138, the third sub-FOV 138. For simplicity, the following will be described with reference only to the first and second sub-FsOV 134, and 136, but it should be understood that extension to imaging of the third sub-FOV 138 may be performed by including a dedicated imaging sensors and optics configured to image the third sub-FOV 138. In examples, a first imaging sensor may be disposed in the top portion 128, with the first image sensor configured to image the first sub-FOV 134. A second imaging sensor may be disposed in the top portion configured to image the second sub-FOV 136. First imaging optics disposed in the housing are be configured to image the first sub-FOV 134 onto the first imaging sensor, and second imaging optics may be configured to image the second sub-FOV 136 onto the second imaging sensor. In examples, the first and second imaging optics may include one or more mirrors, lenses, spatial filters, frequency filters, apertures, or beam splitters.

In implementations, a single imaging sensor may be used to image the first and second sub-FOVs 134 and 136. For example, first imaging optics disposed in the housing 112 image the first sub-FOV 136 onto a first region of pixels of an imaging sensor, and second imaging optics disposed in the housing 112 image the second sub-FOV 136 onto a different second region of pixels of the same imaging sensor. While described as imaging the first and second sub-FsOV 134 and 136, imaging systems having the third sub-FOV 138 may also use a dedicated imaging sensor to independently image the third sub-FOV 138, or may use a single same imaging sensor to image the first, second, and third sub-FsOV 134, 136, and 138. Additionally, third imaging optics may be disposed in the housing 112 configured to image the third sub-FOV 138 onto the imaging sensor. In examples, the one or more imaging sensors may be disposed in the raised housing 126 of the imaging system 106, and/or in the lower housing 124. For example, one or more imaging sensors may be disposed in the raised housing behind the second window 132 to image the first and second sub-FsOV 134 and 136, and another imaging sensor may be disposed in the lower housing 124 below the first window 130. In other embodiments, a single imaging sensor may be used to image all of the sub-FsOV. For example, a single imaging sensor may be disposed in the upper raised housing 126, and optics (e.g., folding mirrors, lenses, etc.) may image all three of the first, second, and third sub-FsOV 134, 136, and 138 onto different regions of the imaging sensor. Conversely, the single imaging sensor may be disposed in the lower housing 124 and imaging optics (e.g., mirrors, folding-mirrors, lenses, etc.) may imaging all three of the first, second, and third sub-FsOV 134, 136, and 138 onto the single imaging sensor in the lower housing 124. In embodiments with the imaging sensor disposed in the raised housing 126, the imaging sensor may be disposed perpendicularly to the top surface 128a, in a landscape orientation with a longer edge of the image sensor disposed parallel to the proximal and distal edges 160 and 162. Additionally, in embodiments with the image sensor disposed in the lower housing 124, the image sensor may be oriented generally perpendicularly to the top surface 128a, but may be oriented such that the active area of the image sensor is parallel to the top surface 128a.

The first optics may further be configured to rotate the first sub-FOV 134 around the first axis A, and the second optics may be configured to rotate the second sub-FOV 136 around the second axis B. For example, the first optics may be configured to rotate the first sub-FOV 134 in a counter-clockwise direction about the axis A (toward the axis C), and the second optics may be configured to rotate the second sub-FOV 136 in a clockwise direction about the axis B (e.g., toward the central axis C). In implementations, the sub-FsOV 134 and 136 may be rotated about 10 degrees about each respective axis, and relative to the platter. The sub-FsOV 134 and 136 may be rotated by about 5 degrees, 10 degrees, 15 degrees, between 0 and 10 degrees, between 0 and 15 degrees, or between 0 and 25 degrees either clockwise or counter-clockwise about an axis. Due to the relative positions of illumination sources in the housing 126, rotating the FsOV can reduce, or eliminate, the imaging of internal reflections from the illumination sources onto the image sensor.

FIG. 5 illustrates a front view of the raised housing 126 and the second window 132. The first sub-FOV 134 and the second sub-FOV 136 overlap at the second window 132 forming the overlap region 142. At the plane of the second window 132, the overlap region 142 may cover less than 5% of the area of the second window 132, less than 10% of the area of the second window 132, less than 15% of the area of the second window 132, less than less than 25%, between 10% and 20%, between 20% and 30%, or between 30% and 50%. In a specific embodiment, the overlap region 142 covers about 18.75% of the area of the second window 132. of the area of the second window 132. Together, the first and second sub-FsOV 134 and 136 substantially span the width and length of the second window 132 at the plane of the second window 132. In examples, the first and second sub-FsOV 134 and 136 together cover greater than 50%, greater than 60%, greater than 70%, greater than 80% or greater than 90% of the area of the second window 132. In examples, as illustrated, the total width of the combined first and second sub-FsOV 134 and 136 (i) span the entire width of the second window 132 at a portion of the second window 132, and (ii) span the entire height of the second window 132 at a portion of the second window 132. The first and second sub-FsOV 134 and 136 illustrated in FIG. 5 are each independently rotated such that the two sub-FsOV overlap, and such that the total combined heights and widths of the sub-FsOV span the width and height of the second window 132.

FIG. 6 illustrates an example imaging sensor 600 for capturing images of one or more FsOV. The imaging sensor may be used entirely to capture separate images of the first sub-FOV 134, the second sub-FOV 136, and the third sub-FOV 138. In implementations, the single imaging sensor may be used to simultaneously, or nearly simultaneously capture images of the first, second, and third sub-FsOV 134, 136, and 138. For example, as illustrated, in FIG. 6, the top left region 602 may include a subset of pixels that captures an image of the first sub-FOV 134, the top right region 605 may include a subset of pixels that captures an image of the second sub-FOV 136, and implementations with a third sub-FOV 138, the bottom region 608 includes pixels that capture an image of the third sub-FOV 138. As illustrated, the top left region 602 is adjacent and disposed lateral to the top right region 605, and the bottom region 608 is disposed longitudinally offset from the first and second regions 602 and 605. In a specific example, the imaging sensor 600 has a total of 2592×1944 pixels, and the top left region 602 includes a subset of 1296 by 1060 pixels, the top right region 605 includes a subset of 1296×1060 pixels, and the bottom region 608 includes a set of 2592×884 pixels. It should be understood that other implementations of using subpixels arrays for capturing a plurality of FsOV are envisioned, including capturing only 2 FsOV on a same imaging sensor, and capturing four or more images of FsOV on subsets of pixels of an imaging detector.

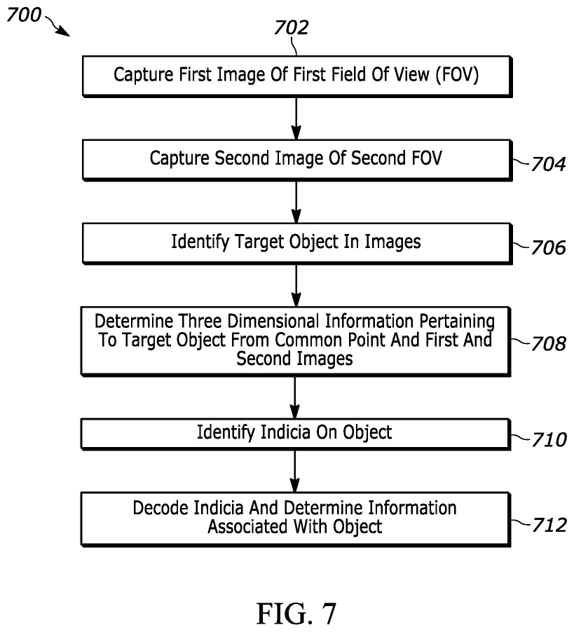

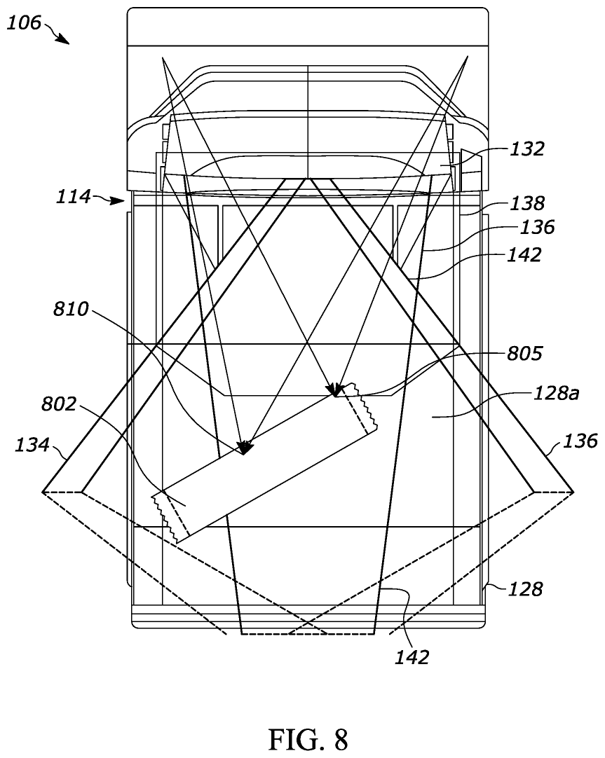

FIG. 7 illustrates a flowchart for a method for performing a three-dimensional measurement using an imaging system. The method of FIG. 7 may be implemented by the imaging system 106 of FIGS. 1 through 5. FIG. 8 illustrates a top view of a target object 802 being partially disposed in the overlap region 142 of the imaging system 106 of FIGS. 1-5. For clarity, the method of FIG. 7 will be described with reference to elements of FIGS. 1-5, and FIG. 8. A process 700 begins at block 702 with a first image being captured by an imaging sensor. The first image is captured of the first field of view, such as the first sub-FOV 134, and the target object may be in the first sub-FOV 134. At block 704 a second image of a second FOV, such as the second sub-FOV 136, is captured by the imaging sensor. The target object 802 may be in the second sub-FOV 136 and therefore captured in the second image. The imaging sensor captures the first image on a first region of the imaging sensor and the second image on a second region of the imaging sensor.

At block 706 the processor 116 identifies the target object 802 in the first and second images. The processor 116 determines where the object is in the first sub-FOV from the first image, and where the object is in the second sub-FOV from the second object. At block 708, the processor determines three-dimensional information pertaining to the object from the first image data and the second image data. To determine the three-dimensional information, the processor may identify a common point in the first and second images and use the common point to further determine the three-dimensional information. For example, with reference to FIG. 8, the processor 116 may determine a first common point 805 of the target object 802 imaged in the overlap region 142. The first common point 805 may be at or near an edge, corner, along a surface, at a specified feature, at a bottom, at a top, or at another part or portion of the target object 802. The first common point 805 in the first and second images may be used to perform stereoscopic imaging analysis to generate three-dimensional data and information pertaining to one or more of a distance or a location of the target object in the first sub-FOV 134, second sub-FOV 136, or overlap region 142. The three-dimensional information pertaining to the target object 802 may be indicative of a shape, geometric feature, location of a feature (e.g., a barcode, numerals, alphanumeric characters, etc.), size of one or more dimensions of the target object 802, an orientation of the target object 802 (e.g., yaw, pitch, tilt, etc.), one or more curvatures of a surface, a number of distinct objects, and/or one or more dimensions or distances between elements or features of the target object 802.

In examples, the processor 116 may determine more than one common point in the first and second images. For example, the processor 116 may determine a second common point 810 of the target object 802 in the first and second images. The second common point 810 may be used to determine the three-dimensional information independently, or in conjunction with, the first common point 80-5. In examples, the processor 116 may determine three-dimensional information from the second common point 810 to check or verify the accuracy of the three-dimensional information determined from the first common point 805. Additional three-dimensional information may be determined using two common points such as a planar surface of the target object 802, an angular orientation, a length, a depth, a width, a size, or other geometric and three-dimensional information as previously described.

In determining one or more common points in the first and second images, the system may identify an indicia or element such as a barcode, package corner, optical character recognition character, alphanumeric, a contrast transition etc. The system may then determine the distance of the indicia or element from the camera based on the identified common indicia or element and parallax between the imaging regions of the two FsOV. A reference plane at one or more common elements can then be constructed based on the common point(s) and the parallax, and further, the size of the object may then be determined since the FsOV size at given distances is known. The resolution of the 3D information may be improved using two or more common points or common elements between the first and second images. Using more than one point may allow for further interpolation of the distances and sizes of other points and elements of the object. Additionally, as an example, two points or elements of an object spaced horizontally apart on a surface of the object allow for the determination of the rotation of an objects face about a vertical axis, or angle relative to a plane such as the plane at the second window 132. Similarly, two points or elements spaced vertically apart on the object may be used to determine an objects orientation or rotation about a horizontal axis or angle relative to a reference plane or the second window 132. Additional interpolations of the object may be performed to determine surfaces, edges, and features of the object not imaged in the overlap region 142.

At block 710, the process 700 may further include identifying the location of a barcode or indicia on the target object in one or more of the first and second images. Identification of the location of the indicia may further be included in determining the three-dimensional information pertaining to the target object 802. At block 712, the processor 116 may decode the indicia to determine information associated with the target object 802.

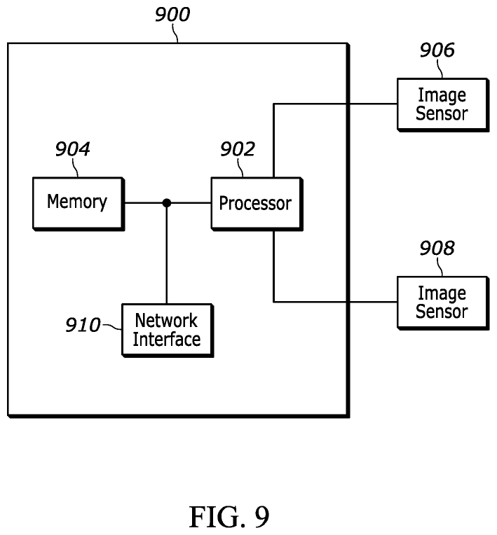

FIG. 9 is a block diagram representative of an example processor platform 900 capable of implementing, for example, one or more components of the example systems for scanning multiple items in a single swipe. The processor platform 900 includes a processor 902 and memory 904. In the example shown, the processor is coupled to a first image sensor 906 and a second image sensor 908. The processor platform 900 and/or one or more of the image sensors 906, 908 may be used to implement the system 100 of FIG. 1 and/or the imaging system 106 of FIGS. 1-5.

The memory capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

The memory (e.g., volatile memory, non-volatile memory) 904 accessible by the processor 902 (e.g., via a memory controller). The example processor 902 interacts with the memory 904 to obtain, for example, machine-readable instructions stored in the memory 904 corresponding to, for example, the operations represented by the flowcharts of this disclosure. Additionally or alternatively, machine-readable instructions corresponding to the example operations described herein may be stored on one or more removable media (e.g., a compact disc, a digital versatile disc, removable flash memory, etc.) that may be coupled to the processing platform 900 to provide access to the machine-readable instructions stored thereon.

The example processing platform 900 of FIG. 9 also includes a network interface 910 to enable communication with other machines via, for example, one or more networks. The example network interface 910 includes any suitable type of communication interface(s) (e.g., wired and/or wireless interfaces) configured to operate in accordance with any suitable protocol(s).

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

We claim:

1. A bioptic indicia reader comprising:
a housing including lower portion having a platter extending along a horizontal plane, and a tower region extending above the platter away from the platter, the tower region having a second window, the first and second windows each having at least one field of view (FOV) passing therethrough, the platter having:
a first window;
a proximal edge toward the tower region;
a distal edge away from the tower region; and two lateral sides opposite each other between the proximal edge and the distal edge;
a length extending between the proximal edge and the distal edge with the length being generally parallel to the lateral sides and midway between the lateral sides defining a centerline of the platter; and
a width extending between the two lateral sides of the platter,
first optics positioned in the housing to image a first FOV of the imaging system, the first FOV extending along a first optical axis through the second window; and
second optics positioned in the housing to image a second FOV of the imaging system, the second FOV extending along a second optical axis through the second window, with the second FOV spatially overlapping with the first FOV to form an overlap region, and wherein the overlap region is a three-dimensional volumetric region that extends along at least 80% of the centerline of the scan platter, the overlap region being a volumetric region in which an object maybe me imaged.

2. The bioptic indicia reader of claim 1, further comprising an imaging sensor disposed in the housing, the imaging sensor positioned in a landscape orientation with a longer side of the imaging sensor disposed parallel to the distal and proximal edges of the platter, wherein an active region of the imaging sensor is configured to (i) image the first FOV on a first region of the imaging sensor, (ii) image the second FOV on a second region of the imaging sensor, the second section being a different section than the first section with the second section being disposed laterally adjacent to the first section.

3. The bioptic indicia reader of claim 2, further comprising third optics positioned in the housing to image a third FOV, the third FOV extending along a third optical axis through the first window, with the third FOV at least partially overlapping with the first FOV and the second FOV, and wherein the imaging sensor further is configured to image the third FOV on a third region of the imaging sensor, the third region being independent from the first region and the second region, with the third region being longitudinally offset from the first region and second region.

4. The bioptic indicia reader of claim 1, wherein the first optics rotate the first field of view around the first optical axis, and the second optics rotate the second field of view around the second optical axis.

5. The bioptic indicia reader of claim 1, wherein the overlap region at the second window covers a height of at least 75% of the second window.

6. The bioptic indicia reader of claim 1, wherein the first FOV and the second FOV together cover at least 80% of the second window.

7. The bioptic indicia reader of claim 2, further comprising a processor and computer-readable media storage having machine-readable instructions stored thereon that, when the machine-readable instructions are executed, cause the system to:
capture, by the first region of the imaging sensor, first image data of an object in the first FOV;
capture, by the second region of the imaging sensor, a second image data of the object in the second FOV;
evaluate, by the processor, the first image data to identify the object in the first FOV;
evaluate, by the processor, the second image data to identify the object in the second FOV;
determine, by the processor, three-dimensional information pertaining to the object from the first image data and second image data.

8. The bioptic indicia reader of claim 7, wherein the machine-readable instructions further cause the system to:
identify, by the processor, indicia in the first image data or the second image data; and
decode, by the processor, the indicia to determine information associated with the object.

9. The bioptic indicia reader of claim 7, wherein to determine the three-dimensional information, the machine-readable instructions further cause the system to:
identify, by the processor, at least one common point between the first image and the second image; and
determine, by the processor, the three-dimensional information of the object from the determined at least one common point.

10. The bioptic indicia reader of claim 7, wherein the overlap region has a volume of 80 cubic inches or greater.

11. A method of performing a three-dimensional measurement, the method comprising:
capturing, on a first region of an imaging sensor, a first image of an object in a first FOV, the first field of view being along a first optical axis through a vertical window;
capturing, on a second region of the imaging sensor with the second region being laterally adjacent to the first region, a second image of the object in a second FOV, the second FOV being along a second optical axis through the vertical window, wherein at least at portion of the object is disposed in an overlap region of the first FOV and the second FOV; and
determining, by the processor, three-dimensional information pertaining to the object from the first image and second image.

12. The method of claim 11, wherein the first FOV and second FOV extend across a length and width of a surface of a platter, the length of the platter extending between a proximal edge of the platter toward the vertical window to a distal edge of the platter away from the vertical window, and a width of the platter extending between two lateral sides of the platter opposite each other between the proximal edge and distal edge.

13. The method of claim 11, wherein the three-dimensional information includes at least one of a distance of the object, a shape of the object, a size of one or more dimensions of the object, an orientation of the object, one or more curvatures of a surface of an object, a number of distinct objects, and one or more dimensions or distances between elements or features of an object.

14. The method of claim 11, wherein the first field of view is rotated about a first optical axis, and the second field of view is rotated about a second optical axis.

15. The method of claim 12, wherein the overlap region spans at least 80% of the length of the surface of the scan platter.

16. The method of claim 11, wherein the overlap region has a volume of 80 cubic inches or greater.

17. The method of claim 11, wherein the first FOV and the second FOV together cover at least 80% of the second window.

18. The method of claim 12, wherein the imaging sensor is disposed in a landscape orientation with a longer side of the imaging sensor disposed parallel to the distal and proximal edges of the platter, wherein an active region of the imaging sensor is configured to (i) image the first FOV on a first region of the imaging sensor, (ii) image the second FOV on a second region of the imaging sensor, the second region being a different region than the first region with the second region being disposed laterally adjacent to the first region.
